(19) United States
(12) Patent Application Publication
(10) Pub. No.: US 2007/0010118 A1
(43) Pub. Date: Jan. 11, 2007

(54) Tube holder structure of a fluorescent lamp

(76) Inventors: Zhong Xing Li, Foshan (CN); Wolfgang Pabst, Munchen (DE); Jie Zhang, Foshan (CN)

Correspondence Address: OSRAM SYLVANIA INC, 100 ENDICOTT STREET, DANVERS, MA, 01923, US

(21) Appl. No.: 11/478,644

(22) Filed: Jul. 3, 2006

(30) Foreign Application Priority Data
Jul. 5, 2005 (CN) 200510085909.2

(51) Int. Cl. H01R 33/02

(52) U.S. Cl. 439/226

(57) ABSTRACT

A fluorescent lamp mainly includes a lamp tube (1), a tube holder (2) and a lamp cap (3), wherein the tube holder (2) has one end fixed to the lamp cap (3) and the other end assembled to the lamp tube (1), characterized in that the walls (2-6) of the tube holder (2) are moved outward in radial direction, thereby substantially circularity gaps (2-3) are formed between the walls (2-6) and the end parts (1-2) of the lamp tube (1), and that the gaps (2-3) are filled with suitable heat insulating material (5) having low heat conduction and resistance to high temperature. An advantage of the lamp is that the hottest parts (2-2) of the tube holder (2) no longer melt and thereby safety is ensured, and that smoke or blackening will not appear any longer. Such fluorescent lamp will enjoy more popularity of the users.

### TECHNICAL FIELD

The present invention relates to the field of lighting, more particularly to the field of structure of a fluorescent lamp.

### BACKGROUND ART

At present, most of fluorescent lamps comprise a lamp cap 3, a tube holder 2, a lamp tube 1 and so on, the structures of which are illustrated in FIG. 1. As seen from the schematic diagram of FIG. 1, the lamp tube 1 is assembled at one end of the tube holder 2, and the lamp cap 3 is fixed at the other end of the tube holder 2. When a fluorescent lamp has been in use for a certain period of time, particularly close to the end of the lamp life, some parts of the glass tube will become overheated, and will reach the highest temperature especially at the very end of its life. However, since a tube holder 2 is usually made of plastic, under such high temperatures, the parts of the plastic tube holder 2 around the lamp tube with blazing filaments 4 inside (or hottest parts 2-2 for short) possibly melt and expose some life electrical parts, thereby lead to a safety risk. The plastic material may also emit smoke and turn black, which would have negative effect on the users and cause accident. Nowadays lamps tend to be made more and more compact, hence the lamp tube having blazing filaments inside will get closer and closer to the hottest parts 2-2 of the tube holder. Unfortunately, the problem concerning smoke emission and blackening remains unresolved.

### DISCLOSURE OF THE INVENTION

An object of the present invention is to provide an improved structure of a fluorescent lamp in which the plastic tube holder 2 will neither get overheated and melt and expose the life electrical parts, nor emit smoke or turn black.

The object of the present invention is achieved by use of such a fluorescent lamp mainly comprising a lamp tube 1, a tube holder 2 and a lamp cap 3, wherein said tube holder 2 has one end fixed to said lamp cap 3 and the other end assembled to the lamp tube 1, characterized in that, the walls 2-6 of the tube holder 2 are moved outward in radial direction, thereby substantially circularity gaps 2-3 are formed between the walls 2-6 and the end parts 1-2 of said lamp tube 1, and that said gaps 2-3 are filled with suitable heat insulating material 5 which possesses low heat conduction and resistance to high temperature. Furthermore, appropriate size and shape of the gaps in combination with suitable heat insulating material ensure that the phenomenon of smoke emission will never appear till the cooling of the lamp.

It is the advantage of the present invention that the hottest parts 2-2 of the tube holder 2 will not melt any longer, and the safety risk of exposing life electrical parts and phenomenon of smoke emission never occurs. Such a fluorescent lamp will enjoy more popularity of users and more safety.

### DESCRIPTION OF THE DRAWINGS

The present description contains the following figures.

FIG. 1 shows the main structure of a prior art fluorescent lamp.

FIG. 2, including FIG. 2A and FIG. 2B, shows the first embodiment of an improved fluorescent lamp structure of the present invention, i.e. the structure wherein a circularity gap is formed at certain position on the tube holder.

FIG. 3 shows the second embodiment of the improved fluorescent lamp structure of the present invention, i.e. the structure wherein the gap as shown in the structure of the first embodiment is filled with heat insulating material.

FIG. 4 including FIG. 4A and FIG. 4B and FIG. 5 including FIG. 5A and FIG. 5B show the third embodiment of the improved fluorescent lamp structure of the present invention, i.e. the structure wherein the gap as shown in the structure of the first embodiment is changed to a horn mouth shape.

FIGS. 6 and 7 show the fourth embodiment of the improved fluorescent lamp structure of the present invention, i.e. the structure wherein the gap as shown in the structure of the third embodiment is filled with heat insulating material.

The same reference numeral represents the same part throughout the above figures.

### BEST MODE OF CARRYING OUT THE INVENTION

The present invention will be described in details hereunder with reference to the figures.

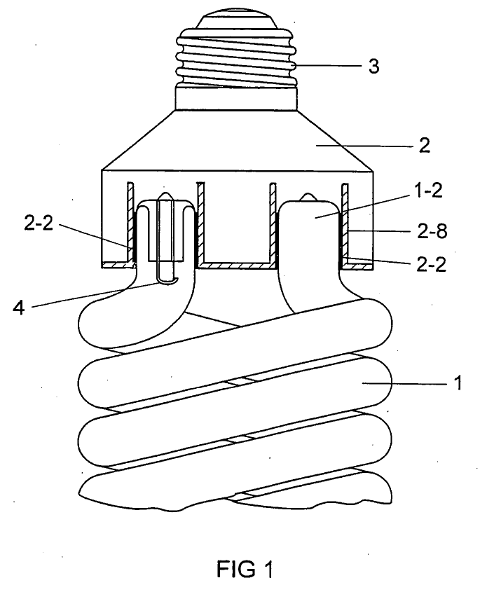

Referring to FIG. 1, as described above, a prior art fluorescent lamp mainly comprises a lamp tube 1, a tube holder 2, a lamp cap 3 and so on. The lamp tube 1 exemplified in this figure is a spiral lamp tube bent from a long and thin glass tube, but the lamp tube of any other shape also applies to the present invention. The lamp tube 1 has two ends 1-2 inserted into the inner barrels 2-8 of the tube holder 2. Therefore, lamp tube 1 is assembled to the tube holder 2 by way of such insertion of these ends 1-2 into the inner barrels 2-8 of the tube holder 2. There are tiny spaces between these ends 1-2 and the inner barrels 2-8, allowing for the application of cement with resistance to high temperature. In this way, these ends 1-2 of the lamp tube 1 are further bound with the inner barrels 2-8, so that the lamp tube 1 is well attached to the tube holder 2 and that the ends 1-2 of the lamp tube 1 and the walls of the inner barrels 2-8 are in contact. Filaments 4 are fixed inside the ends 1-2 of the lamp tube 1 and generate heat when they are ignited. In particular, at the end of the lamp life, the heat radiation heats the ends 1-2 of the lamp tube 1, and therefor heats the walls of the inner barrels 2-8 of the tube holder 2. The lower portions of the inner barrels 2-8 are the regions closest to the filaments 4, i.e. the so-called hottest parts 2-2, which are typically circularity wall with the axial length of several millimeters. These parts often melt due to high temperature, thus life electrical parts are exposed, and safety risks and ill effects, such as smoke emission, blackening and so on will occur.

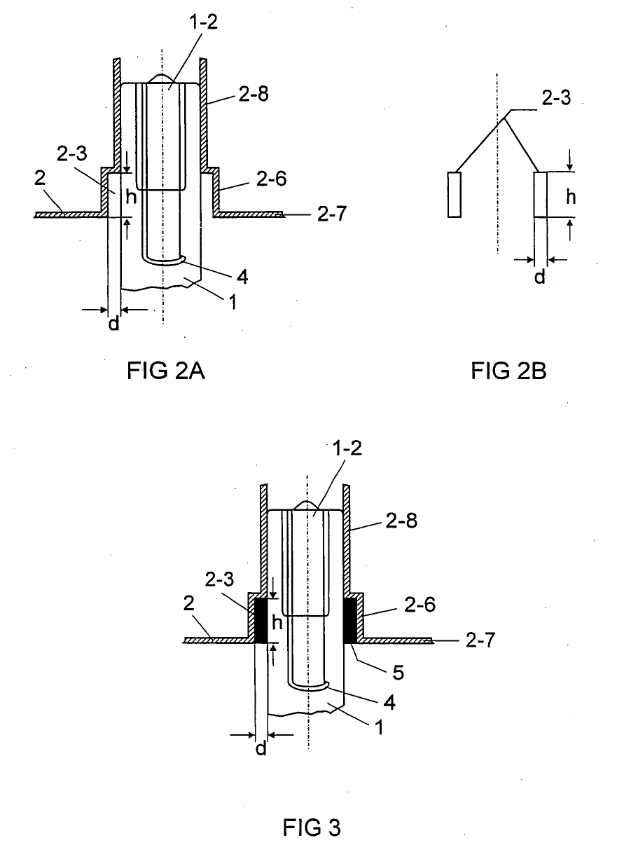

Referring to FIG. 2, FIG. 2 shows the first embodiment of an improved fluorescent lamp structure of the present invention. FIG. 2 are partial views including FIG. 2A and FIG. 2B. FIG. 2A show the modification of the main structure. To solve the problems shown in FIG. 1, the present invention adopts such a structure that, the walls 2-6 of the inner barrels 2-8 inside the tube hold 2, measured h in length from the bottom 2-7, are moved outward by a distance of d in radial direction. The moved walls 2-6 basically cover the portions which may cause smoke emission and turn black, and the length h basically equals to or slightly exceeds the height of the aforesaid portions.

The distance d by which the walls 2-6 are moved outward is such an amount that can lower, and preferably substantially lower the temperature of the walls 2-6. In this way, said walls 2-6 will not overheat or melt any time during the life of the fluorescent lamp, and the phenomenon of smoke emission and blackening will not appear till the cooling of the lamp at the end of its life.

Distance d is an amount by which the walls 2-6 at the lower portions of the inner barrels 2-8 are moved outward from the outer surfaces of the ends 1-2 of the lamp tube, and d is typically within several millimeters.

Since the walls 2-6 at the lower portions of the inner barrels 2-8 are moved outward in radial direction, the gaps 2-3 are formed in between. Because the lamp tube 1 is usually a cylinder and its ends 1-2 are also shaped as a cylinder, said gaps 2-3 are basically circularity around the ends 1-2, i.e. basically ring-like gaps. FIG. 2B shows the section location and rectangle (h×d) section of the gap 2-3, which is a separated view from FIG. 2A.

Due to the existence of the circularity gaps 2-3, the hottest parts 2-2 of the walls which formerly overheat and emit smoke will no longer get so hot as to overheat and emit smoke. The radial spacing dimension of the circularity gaps 2-3 basically equals to d. In the following, d also represents the spacing dimension of the circularity gaps 2-3.

Referring to FIG. 3, FIG. 3 shows another embodiment of the improved fluorescent lamp structure of the present invention, which makes some changes on the basis of the embodiment in FIG. 2, i.e. filling the circularity gaps 2-3 with heat insulating material 5. The heat insulating material 5 has resistance to high temperature, hardly burns and has low heat conduction. The material is preferably a kind of low cost material, such as silicon powder, silica gel and so on. A cement having resistance to heat is used as bond, which is filled in the gaps 2-3 after being mixed with the silicon powder.

In the example, a ring 5-1 having resistance to high temperature also can be used as the heat insulating material 5, which is directly placed on the ends 1-2 of the lamp tube 1. After assembly, said ring 5-1 is squeezed into the gap 2-3.

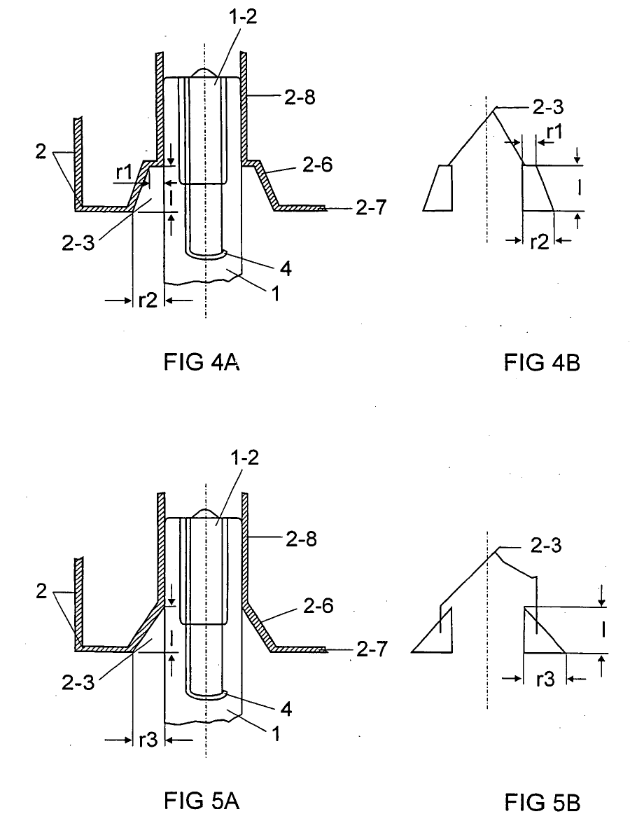

Referring to FIGS. 4 and 5, FIGS. 4 and 5 both show another embodiment of the improved fluorescent lamp structure of the present invention, which makes some changes on the improved structure based on the embodiment in FIG. 2. That is, the structures and shapes of the walls 2-6 and the adjacent gaps 2-3 are changed. The lower portions of the walls 2-6, i.e. one end of the bottom 2-7 of the lamp holder 2 is pulled outward, for example by a distance of r3, so that the cross section of the gap 2-3 is shaped as right-angled triangle, as shown in FIG. 5A. FIG. 5B shows the triangle shape of the gap 2-3. As another structural improvement, the upper portions of the walls 2-6 are pulled outward in radial direction by a distance of r1, and lower portions are pulled outward in radial direction by a distance of r2, so that the cross section of the gap 2-3 is shaped as right-angled trapezoid, as shown in FIGS. 4A and 4B respectively. These gaps are all horn mouth, therefore the structures concerned may also be referred to as an inverted-V structure.

The dimensions relating to the gaps 2-3, i.e. r1, r2, r3, h, l and d, are all selected within several millimeters, which may be determined according to some experiments. All the dimensions mentioned above are typically within several millimeters.

The cross section of the gap 2-3 may be many other shapes, such as S shape, sawtooth shape and so on, which are all within the scope of the present invention.

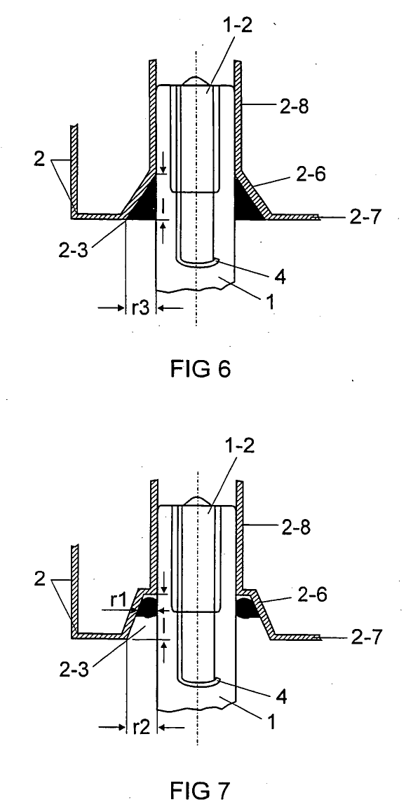

Referring to FIG. 6 and FIG. 7, FIG. 6 and FIG. 7 show the structures wherein the circularity gaps 2-3 are filled with the heat insulating material 5 on the basis of the embodiment structures in FIG. 4 and FIG. 5.

FIG. 6 shows an example wherein the gaps 2-3 are full of the heat insulating material 5, while FIG. 7 shows an example of the gaps being partially filled. The cross sections of the gaps 2-3 in FIG. 6 are triangle, while the ones in FIG. 7 are trapezoid, both of them are in the shape of a horn mouth.

While filling heat insulating material 5 in the gap 2-3, if an expected object can be achieved when the gaps 2-3 is not yet full of the heat insulating material 5, the gap need not be completely filled, the example as shown in FIG. 7. Of course, the gaps can be completely filled, which is the example as shown in FIG. 6.

The structure for filling the gaps 2-3 with the heat insulating material 5 applies to every structure as shown in each embodiment of the present invention, and certainly applies to the rectangular cross section shown in FIG. 2, as well as to other circumstances where the shapes of the gaps 2-3 are changed.

It is an advantage of the gaps 2-3 shaped as horn mouth in FIG. 4 to 7 that, since the hottest points of the hottest parts 2-2 are close to the bottom 2-7, the horn-shaped structure enables the hottest points to be substantially moved outward, so that the possibility for the hottest parts 2-2 to get overheated is greatly reduced, and thereby the object of the present invention is achieved properly.

Each embodiment shown in FIGS. 3, 6 and 7 shows the combinations of the gaps 2-3 with the heat insulating material 5. Such combinations ensure that smoke will never appear till the cooling of the lamp.

1. A fluorescent lamp, mainly comprising a lamp tube, a tube holder and a lamp cap, wherein said tube holder has one end fixed to said lamp cap and the other end assembled to the lamp tube, and wherein the walls of said tube holder are moved outward in radial direction, thereby substantially circularity gaps are formed between said walls and the end parts of said lamp tube.

2. The fluorescent lamp according to claim 1, wherein the sections of said gaps are of rectangle shape, triangle shape or trapezoid shape, or any other shape.

3. The fluorescent lamp according to claim 2, wherein the dimensions h, d, r1, r2, r3 and l of said gaps are selected as being within several millimeters.

4. The fluorescent lamp according to claim 1, wherein said gaps are filled with suitable heat insulating material which possesses low heat conduction and resistance to high temperature.

5. The fluorescent lamp according to claim 1, wherein the sections of said gaps are of rectangle shape, triangle shape or trapezoid shape, or any other shape, and wherein said gaps are filled with suitable heat insulating material which possesses low heat conduction and resistance to high temperature.

6. The fluorescent lamp according to claim 4, wherein said heat insulating material is cement, preferably silica gel.

7. The fluorescent lamp according to claim 4, wherein said heat insulating material is a ring with resistance to high temperature.

8. The fluorescent lamp according to claim 1, wherein said gaps may be completed or partially filled with the heat insulating material.

9. The fluorescent lamp according to claim 2, wherein said gaps are filled with suitable heat insulating material which possesses low heat conduction and resistance to high temperature.

10. The fluorescent lamp according to claim 2, wherein said gaps may be completed or partially filled with the heat insulating material.
